(19) United States
(12) Patent Application Publication
(10) Pub. No.: US 2003/0051958 A1
(43) Pub. Date: Mar. 20, 2003

(54) Adaptive shock and vibration attenuation using adaptive isolators

(76) Inventors: Sven K. Esche, Hoboken, NJ (US); Jan Nazalewicz, Mahwah, NJ (US)

Correspondence Address: LICATLA & TYRRELL P.C., 66 E. MAIN STREET, MARLTON, NJ, 08053, US

(21) Appl. No.: 09/954,994

(22) Filed: Sep. 18, 2001

(51) Int. Cl. F16F 7/10

(52) U.S. Cl. 188/379

(57) ABSTRACT

Device for adaptive vibration attenuation using passive isolators and pneumatic or mechanical actuators are provided.

### FIELD OF INVENTION

The present invention relates to adaptive vibration attenuation devices which combine conventional passive isolators having a highly nonlinear stiffness with a pneumatic or mechanical actuator. The devices of the present invention allow adaptive and one-directional or bi-directional stiffness adjustment with significantly improved performance compared with the existing passive and active shock and vibration isolators. The devices are useful for automotive suspension systems, engine mounts, vibration mounts for heavy manufacturing equipment, vibration mounts for large equipment whose dynamical system properties are affected by environmental changes, vibration mounts for piping with varying dynamic parameters, protection against seismic events, sound attenuation in submarines.

### BACKGROUND

Shocks and vibrations occur in virtually all engineering fields. In the overwhelming majority of the cases, these vibrations lead to excess noise, increased wear and tear and in some cases instability and failure. Accordingly, shocks and vibrations are highly undesirable, and a multitude of vibration attenuation devices, referred to hereinafter as isolators, have been devised. By dissipating energy, these devices protect fragile objects from vibration or shock loads or reduce the forces transmitted to the environment. By purposely dissipating energy, isolators either reduce the forces transmitted to the environment from equipment that excites vibrations, including, but not limited to, sheet metal transfer press, forging presses, or protects fragile or high precision equipment from vibration or shock loads, including, but not limited to, sheet metal transfer presses, forging presses, or protects fragile or high precision equipment from vibration or shock loads, including, but not limited to, high-precision manufacturing equipment in the semiconductor and optical industries.

The various types of isolators in existence can be grouped into passive isolators or active isolators. Passive isolators are devices with fixed system parameters that need to be tailored toward a specific application. Their design is thus determined by the dynamic mass to be supported, the type of dynamic disturbance e.g., shock, random sinusoidal vibration; the frequency spectrum of the disturbance; the environmental conditions, e.g. temperature, humidity, atmospheric pressure, altitude; the available sway space and the desired level of attenuation. Passive isolators have been used to reduce the forces transmitted from a vibration source to the environment. Examples are support mounts for manufacturing equipment such as presses and engine mounts in automobiles and other means of transportation. Passive isolators prevent fragile objects from getting damaged or affected by surrounding events, e.g. semiconductor and optical manufacturing equipment, high precision measurement devices or simple shipping container isolators. These passive devices are typically relatively affordable, but less versatile when compared with recently appearing active isolators.

The general function carried out by active isolators which are essentially feedback control devices is to sense the impending dynamical disturbance and cancel or dampen the resulting motion by actively controlled actuation that is analogous but opposite in phase to the disturbance. The actuation is commonly achieved by pneumatic, hydraulic, piezoelectric or magnetostrictive drivers where each of these types of drivers is most favorably applicable in its own range of amplitudes, frequencies and supportable dynamic masses. While such active isolators often allow for favorable attenuation results they also exhibit a number of shortcomings the most significant being, high energy consumption for generating the continuous actuation.

U.S. Pat. Nos. 4,674,725; 4,742,998; 4,757,980; 5,174,552; 5,954,169; and 6,029,959 describe adaptive adjustment of dynamic stiffness and dampening of isolators.

U.S. Pat. No. 4,859,817, U.S. Pat. No. 4,866,854, U.S. Pat. No. 4,942,671, U.S. Pat. No. 5,074,052, U.S. Pat. No. 5,412,880; U.S. Pat. No. 5,428,446, U.S. Pat. No. 5,179,525; U.S. Pat. No. 5,887,356, U.S. Pat. No. 5,909,939 and U.S. Pat. No. 6,086,283 describe coordinate measuring machines with stationary baseplates and adjustable components. U.S. Pat. No. 5,319,858 describes a touch probe with a stylus-supporting member supported with respect to a housing at six points of contact. U.S. Pat. No. 6,205,839 describes equipment for calibration of an industrial robot which has a plurality of axes of rotation, and a measuring device adapted for rotatable connection to a reference point during the calibration process. U.S. Pat. No. 5,791,843 describes a device for controlling the orbital accuracy of a work spindle. Other patents which describe measurement devices with moveable supports include: U.S. Pat. No. 4,777,818; U.S. Pat. No. 5,052,115; U.S. Pat. No. 5,111,590; U.S. Pat. No. 5,214,857; U.S. Pat. No. 5,428,446; U.S. Pat. No. 5,533,271; U.S. Pat. No. 5,647,136; U.S. Pat. No. 5,681,981; U.S. Pat. No. 5,720,209; and U.S. Pat. No. 5,767,380.

The successful development of improved vibration attenuation technologies has the potential for positively impacting a wide range of applications that are of high relevance to the U.S. economy such as manufacturing machinery, land, air, water and space transportation, electronic and optical equipment.

The present invention provides innovative methods for the adaptive attenuation of shocks and vibrations.

### SUMMARY OF THE INVENTION

An object of the present invention is to provide a device for adaptive vibration attenuation with a passive isolator and a pneumatic actuator which varies stiffness characteristics.

Another object of the present invention is to provide a device for adaptive vibration attenuation with a passive isolator and a mechanical actuator which varies stiffness characteristics.

### BRIEF DESCRIPTION OF THE DRAWINGS

FIG. 1 shows a side view of a pneumatic system with two pressure chambers.

FIG. 2 shows a side view of a mechanical system.

### DETAILED DESCRIPTION OF THE INVENTION

The present invention provides a device for adaptive vibration isolation of a wide range of supported dynamic masses. This isolation is provided through the combination of a conventional passive isolator, characterized by a highly nonlinear stiffness with a pneumatic actuator that allows one to adaptively and one-directionally or bi-directionally adjust the operating point on the force vs. deflection curve of the passive isolator to provide low incidence of appreciable shocks or vibrations. The present invention provides significantly improved attenuation performance compared with the existing passive and active vibration isolators.

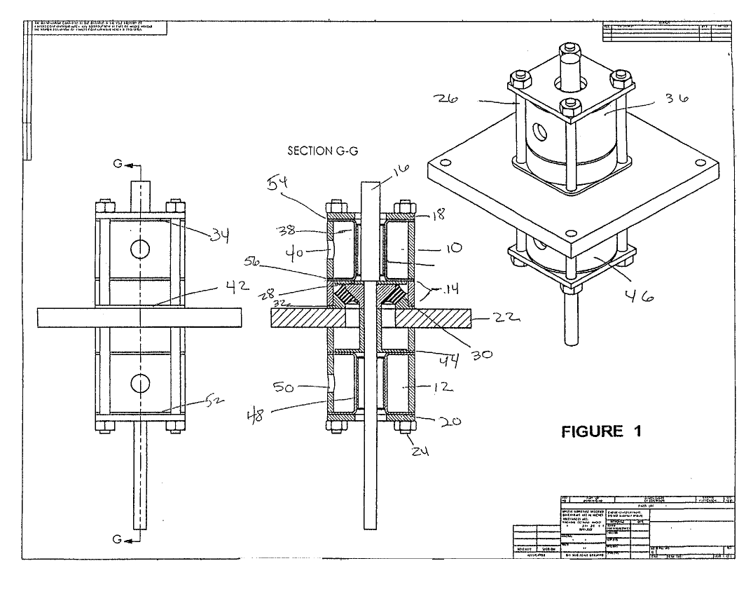

FIG. 1 shows a side view of a pneumatic unit comprising an upper pressure chamber 10 and a lower pressure chamber 12 present on either side of an non-linear spring 14, a load supporting rod 16, a top support plate 18, a bottom support plate 20, a supporting plate 22, fasteners 24 and connectors 26. The non-linear spring 14 is comprised of an upper metal support 28, an elastomeric isolator 30, and a lower metal support 32. The upper pressure chamber is comprised of a top side 34, an upper cylindrical side wall 36 with a top edge and a bottom edge, upper rubber bellows 38, an upper air inlet 40, and a bottom side to the upper pressure chamber 42. The lower pressure chamber 12 is comprised of a top side 44, a lower cylindrical side wall 46, lower rubber bellows 48, a lower air inlet 50, and a bottom to the lower pressure chamber 52. The upper pressure chamber contains rubber bellows with a top edge 54 and bottom edge 56. The top edge 54 of the upper rubber bellow 48 is secured between the underside of the upper pressure chamber top 34 and the top edge of the cylindrical side wall 36. The bottom edge of the upper pressure chamber rubber bellows 56 is secured between the bottom edge of the cylindrical side wall 36 and the top edge of the lower metal support 32 of the nonlinear spring 14. The lower pressure chamber 12 contains a lower rubber bellows 48 with a top and bottom edge. The top edge of the lower rubber bellow 48 is secured between the bottom side of the lower metal support 32 and the top edge of the lower pressure chamber cylindrical side wall 46. The bottom edge of the lower rubber bellow 48 is secured between the bottom edge of the cylindrical side wall 46 and the top edge of the bottom support plate 20. The upper pressure chamber rubber bellows 38 and lower pressure chamber rubber bellows 48 secured in this way each take on a doughnut shape. An upper air inlet 40 present on the cylindrical side wall 36 of the upper pressure chamber 10 allows air to be pumped into the upper pressure chamber 10 which transfers increased load onto the nonlinear spring 14. A top support plate 18 is in contact with the top side of the upper pressure chamber 10. The top support plate 18 is attached by fasteners 24 to connectors 26 which are attached to the top side of a supporting plate 22. The bottom side of the support plate 22 is attached to the bottom support plate 20 by multiple fasteners 24 to the under side of the bottom support plate. A load supporting rod 16 runs from the top support plate 18 through the center of: the space in the center of the upper rubber bellows 38 in the upper pressure chamber 10, the nonlinear spring 14, the supporting plate 22, space in the center of the lower rubber bellows 48 in the lower pressure chamber 60 and the bottom support plate 20. The load supporting rod 16 has a smaller diameter at the lower end and a larger diameter at the upper end. The larger diameter end of the load supporting rod 16 passes through the center of the top support plate 18 and through the space in center of the doughnut shaped upper rubber bellows 38 of the upper pressure chamber 10. Due to its larger dimension, the larger diameter end of the load supporting rod 16 can not pass through the hole in the top of the upper metal support 28 of the nonlinear spring 14. The actuator is part of a pneumatic system including a pump, pressure chambers, and a pressure reservoir to facilitate rapid response times for stiffening and softening. By introducing air into the upper pressure chamber 10, a load is applied to the nonlinear spring. Similarly, the lower pressure chamber 12 reduces the load on the non-linear spring 14. A load due to pressure in the upper chamber is added to the external supported load while a load due to pressure in the lower chamber is subtracted from the external supported load. The nonlinear spring 14 stiffness changes with varying loads. By applying pressure to either the upper pressure chamber 10 or the lower pressure chamber 12, the natural frequency of the system may be regulated. One or two pressure chambers may be present depending on the application. Using this device, adaptive vibration attenuation is implemented by passive vibration mounts that allow the adjustment of their dynamic stiffness characteristics in response to changes in the excitation or loading conditions. The mount stiffness is varied by combining a passive vibration mount with highly non-linear force-deflection characteristics with a one-directional or bi-directional pneumatic actuator. These adjustments of mount characteristics result a change of the natural frequency by shifting the operating point of the nonlinear spring. Non-invasive, non-contact sensors are used together with hardware- or software-based signal processing to identify the excitation displacement and/or force signal and to generate the appropriate adjustments of the passive vibration mount characteristics.

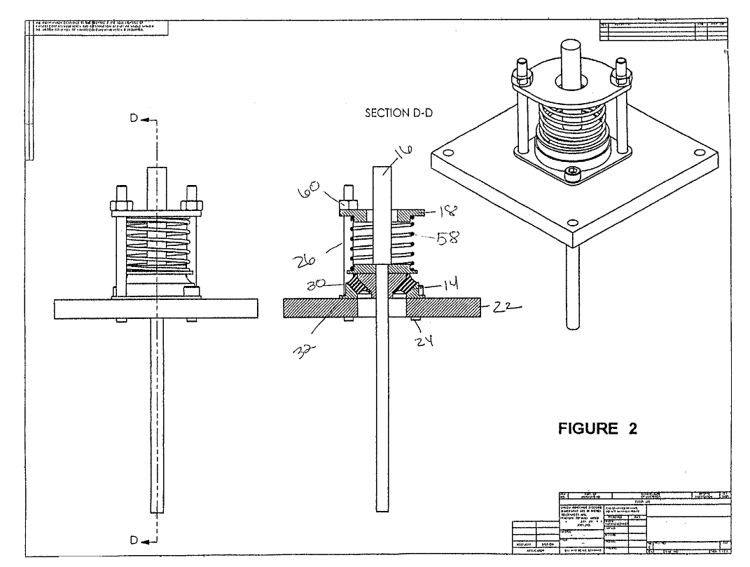

FIG. 2 shows a side view of a mechanical system. In instances where stiffness adjustments do not have to be accomplished remotely or frequently, a less expensive alternative to the pneumatic system is a mechanical pre-tensioning spring. The mechanical unit is comprised of a coil spring 58, a non-linear spring 14, a load supporting rod 16, a top support plate 18, a supporting plate 22, spring adjustments 60, fasteners 24 and connectors 26.

The top support plate 18 contacts the top of the coil spring 58. The bottom of the coiled spring 58 contacts the top of a supporting plate 22. The top support plate 18 is attached to the supporting plate 22 by connectors 26 which are secured by spring adjustment fasteners 60. The pressure on the coiled spring 58 and the non-linear spring is adjusted by spring adjustments fasteners 60.

The load supporting rod 16 has a smaller diameter at the front end and a larger diameter at the back end. The larger diameter end of the load supporting rod 16 passes through the center of the top support plate and through the air space in center of the coiled spring. Due to its larger diameter, it can not pass through the hole in the top of the upper metal support 28 of the nonlinear spring 14. As the coil spring force is varied the front of the larger diameter portion of the load supporting rod 16 transfers the pressure onto the upper metal support 28 of the nonlinear spring 14. The pre-load in the coil spring is adjusted by turning two nuts.

The adaptive vibration attenuation devices of the present invention offer adaptivity to varying excitation and loading characteristics. They are reliable, compact, light weight and consume less power than conventional active isolators (for pneumatic or actuator-adjusted mechanical systems) or no power at all (for manually adjusted mechanical systems). Further in the case of a malfunction in the controller, basic attenuation is still provided.

Adaptive vibration attenuation device of the present invention require an external means of providing a pressurized gas e.g. air.

The pneumatic or mechanical isolators of the present invention overcome limitations of competing actuator principles (e.g. electromagnetic) with respect to the maximum supportable mass.

What is claimed is:

1. A device for adaptive vibration attenuation comprising a passive isolator and a pneumatic actuator which varies stiffness characteristics.

2. A device for adaptive vibration attenuation comprising a passive isolator and a mechanical actuator which varies stiffness characteristics.
